(19) United States
(12) Patent Application Publication
(10) Pub. No.: US 2005/0197272 A1
(43) Pub. Date: Sep. 8, 2005

(54) Packaging coated in a varnish for protecting it against light

(75) Inventor: Alain Bethune, Savigny (FR)

Correspondence Address: OLIFF & BERRIDGE, PLC, P.O. BOX 19928, ALEXANDRIA, VA, 22320, US

(73) Assignee: L'OREAL, Paris (FR)

(21) Appl. No.: 11/067,906

(22) Filed: Mar. 1, 2005

Related U.S. Application Data
(60) Provisional application No. 60/558,575, filed on Apr. 2, 2004.

(30) Foreign Application Priority Data
Mar. 5, 2004 (FR) 04 50455

(51) Int. Cl. C11D 17/00

(52) U.S. Cl. 510/406; 206/524.1; 510/120; 510/130; 546/16

(57) ABSTRACT

The present invention relates to packaging comprising a cardboard sheet coated on its outside in a varnish containing at least one additive for reducing the deterioration of the packaging.

This non provisional application claims the benefit of French Application No. 04 50455 filed on Mar. 5, 2004 and U.S. Provisional Application No. 60/558,575 filed on Apr. 2, 2004.

The present invention relates to packaging, in particular cardboard packaging.

### BACKGROUND OF THE INVENTION

Cardboard sheets generally used for packaging can be characterized by their weight and by the nature of their constituents.

The term “cardboard sheet” refers to a sheet weighing more than 100 grams per square meter (g/m²), and for example weighing not less than 190 g/m², or even not less than 200 g/m².

A distinction is drawn between conifer-based cardboard, also referred to as wood-pulp cardboard, and deciduous tree-based cardboard, also referred to as cellulose cardboard.

In order to manufacture the pulp for wood-pulp cardboard, the bark of conifers is mechanically pulped, thereby leading to fibers that are rather long.

Wood-pulp cardboard generally presents at least 80% by weight of conifer fibers and is yellowish. The fibers include lignin which goes darker under the effect of ultraviolet radiation.

In order to improve surface appearance, printability, or varnishing, and in order to increase whiteness, the cardboard can be coated.

The term “coated cardboard sheet” thus refers to a cardboard sheet that includes a surface coating on one or both of its faces.

Yellowing of lignin-rich cardboard sheet under the effect of visible light and especially of ultraviolet radiation is a very old problem that manufacturers endeavor to solve, since such yellowing greatly reduces the customer-appeal of packaging.

The term “visible light” refers to light at wavelengths lying in the range 400 nanometers (nm) to 800 nm, and the term “ultraviolet light” refers to light at wavelengths lying in the range 280 nm to 400 nm.

In order to avoid being confronted with the problem of yellowing associated with the presence of lignin or in order to minimize this problem, it is possible to use cellulose cardboard which is not as rich in lignin, since it generally contains less than 15% by weight of conifer fibers.

However, such cardboard that uses a raw material that is less widespread in certain regions of the world, and that requires chemical pulping, is usually more costly than wood-pulp cardboard.

In addition, the mechanical rigidity of such cardboard is generally not as good as the mechanical rigidity of wood-pulp cardboard, such that it must be heavier for equal rigidity, thereby restricting the use of cellulose cardboard to costly products.

It is known to delay yellowing of lignin-rich cardboard by the surface coating incorporating a carbon black additive, or an iron- or zinc-oxide based additive, but this degrades the whiteness of the coating and/or makes it less compatible with food products.

In addition, the lignin ends up by migrating into the surface coating, so yellowing is not permanently prevented.

It is also known to laminate a polymeric film containing titanium oxide, but this modifies the appearance and the feel characteristics of the cardboard sheet, and can make said cardboard sheet more difficult to recycle.

In addition, the inks used to print on packaging exist in several grades which are more or less costly depending on their ultraviolet resistance. It is preferable to use highly ultraviolet-resistant grades (values 5 or greater on the lightfastness on the Blue Wool scale ISO 105-B), unless the product is going to be sold quickly.

It is also known to incorporate bleach in cardboard sheets so as to increase whiteness, but such bleach is sensitive to ultraviolet and its effectiveness is thus limited over time.

### SUMMARY OF THE INVENTION

There exists a need to reduce the cost of packaging, but without said reduction being achieved to the detriment of the mechanical properties of the packaging, or to the detriment of its appearance over time, in particular under the effect of ultraviolet radiation.

In the invention, the packaging comprises a cardboard sheet coated on its outside in a varnish containing at least one additive for reducing the deterioration of the packaging under the effect of light, e.g. yellowing of the sheet under the effect of light and/or spoiling of underlying printing.

In the description and the claims, the term “cardboard sheet” refers to a sheet of cardboard or paperboard or like material that is optionally composite and that has substantially the same mechanical behavior as cardboard or paperboard. By way of example, such a composite material still includes plant fibers, in particular more than 40% by weight, and better 50% or even more, the plant fibers being mixed with fibers made of synthetic material, for example.

The invention makes it possible to make packaging with a lignin-rich cardboard sheet, while effectively delaying yellowing of said sheet.

The invention thus makes it possible to use wood-pulp cardboard that is more rigid than cellulose cardboard, and thus makes it possible to reduce the thickness of the cardboard sheet for equal rigidity, thereby reducing the quantity of material used.

Furthermore, the presence of the varnish makes it possible to use underlying inks that are less resistant to ultraviolet, and that are therefore less costly.

The invention thus enables significant savings to be made on the cost of coated packaging.

The invention advantageously applies to cardboard sheets including more than 70%, and better 80% by weight of lignin-rich conifer fibers, for example.

The invention also makes it possible to protect packaging, without said protection necessarily requiring the composition or the thickness of a possible surface coating of the sheet to be modified, thereby enabling its printability characteristics and its mechanical characteristics, in particular its rigidity or its compression strength, to be affected little, if at all.

It is thus possible to continue using existing methods and machines for manufacturing packaging, or for packaging products in such packaging.

The invention does not apply exclusively to coated cardboard sheets, but also relates to non-coated cardboard sheets.

When the invention is applied to coated cardboard sheets, the surface coating may be white, and may, for example, contain at least one optical bleach, which may be present in the surface coating at a concentration lying in the range 0.05% to 0.5% by weight, for example, and better at a concentration lying in the range 0.1% to 0.3%.

The surface coating may present thickness lying in the range 20 micrometers (μm) to 30 μm, for example, and may contain calcium carbonate, and/or clay, in particular kaolin. In an embodiment of the invention, the surface coating contains calcium carbonate and clay substantially in a 60/40 ratio by weight.

The surface coating may also contain a binder, in particular starch, so as to improve its cohesion.

The presence of calcium carbonate, which can, in particular, comprise fine spheroidal grains, can be useful for achieving a smooth surface.

The presence of clay, in particular kaolin, which can present coarse prismatic grains, can be useful for obtaining the desired density for the surface coating.

The thickness of the varnish may lie in the range 2 μm to 20 μm, for example, and better in the range 3 μm to 12 μm, the total thickness of the cardboard sheet lying in the range 100 μm to 1000 μm, for example, and preferably in the range 300 μm to 500 μm.

In the varnish, the additive(s) may be at a total concentration by weight lying in the range 0.5% to 10%, e.g. lying in the range 1% to 6%.

The varnish may include an additive which is a UV absorber compound, e.g. a UV absorber having the following formula:

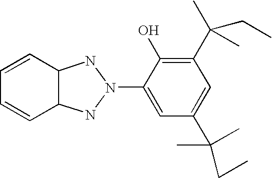

The varnish may also include an additive which is a free-radical absorber compound, in particular a sterically-hindered amine or a Hindered Amine Light Stabilizer (HALS), e.g. a free-radical absorber having the following formula:

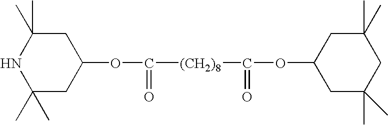

The varnish may be based on an aqueous solvent, said varnish being an acrylic varnish, for example.

In a variant, the varnish may be a varnish that is cross-linkable under the action of UV radiation, thereby removing the need to evaporate water from the cardboard, which can preserve its moisture. In which case, the additive(s) for combating the effects of light is/are selected so as to be compatible with such a varnish. In particular, it is preferable for the varnish not to include free-radical absorbers such as sterically-hindered amines or HALS.

When it is cross-linkable under the action of UV radiation, the varnish can, for example, include two ultraviolet absorbers having absorption spectra that are selected so as to form a range of wavelengths in which absorption is lower, and the lamp used to cause polymerization is thus selected so as to emit in said range.

This makes it possible to prevent the ultraviolet absorbers present in the varnish from fulfilling their protective function, without excessively hindering polymerization of the varnish.

The varnish can include a violet dye, which tends to increase the whiteness of the cardboard sheet.

By way of example, before drying, the sheet may be coated in approximately 3 g/m² to 10 g/m² of varnish, in particular approximately 6 g/m² of varnish.

The invention also provides a method of manufacturing packaging comprising a sheet of cardboard or the like, in which method a varnish is applied to the sheet, said varnish containing at least one additive for reducing the deterioration of the packaging under the effect of light.

The additive may be a UV absorber compound and/or a free-radical absorber.

The varnish may be applied using various techniques, in particular by offset printing, by heliography, by flexography, or by silk-screen printing.

The sheet may be printed prior to the varnish being applied, or after the varnish has been applied.

The sheet is preferably printed before the varnish is deposited, thereby making it possible to protect the ink from ultraviolet radiation, and therefore making it possible to use inks that are less costly.

In another of its aspects, the invention thus provides a cardboard sheet including printing in at least one ink that has low ultraviolet resistance, for example 4 on the Blue Wool lightfastness scale coated in a varnish including at least one ultraviolet absorber and/or one free-radical absorber, in particular one of those mentioned above.

In another of its aspects and independently or in combination with the above, the invention also provides a varnish that is cross-linkable under the action of ultraviolet radiation, and that includes at least two ultraviolet absorbers selected to have absorption spectra that are sufficiently far apart to form between them a range of wavelengths in which absorption is lower, with a view to irradiating in said range while cross-linking the varnish.

The absorption peaks of the two additives are more than 40 nm apart, for example, and form between them a trough in which the absorption low is at least 30% below the maximum absorption defined by one of the peaks, for example.

The varnish can also include a violet dye.

The emission spectrum of the source can be centered in the range about 310 nm to 330 nm, for example.

In another of its aspects and independently or in combination with the above, the invention also provides a cardboard sheet coated in a varnish including at least one additive constituting a UV absorber and/or a free-radical absorber.

### BRIEF DESCRIPTION OF THE DRAWINGS

The invention can be better understood on reading the following detailed description of non-limiting embodiments thereof, and on examining the accompanying drawing, in which:

FIG. 1 is a perspective diagram showing an example of packaging in accordance with the invention, made by folding a sheet of cardboard or the like, coated in a varnish;

FIGS. 2 to 4 are diagrammatic and fragmentary sections showing a coated cardboard sheet illustrating various embodiments of the invention; and

FIG. 5 is a graph showing absorption as a function of the wavelength for an example of a suitable varnish.

### MORE DETAILED DESCRIPTION

The invention applies to any type of packaging that is made by folding, sizing, and/or rolling one or more sheets of cardboard or the like, and in particular it applies to boxes for containing receptacles containing cosmetics or care products.

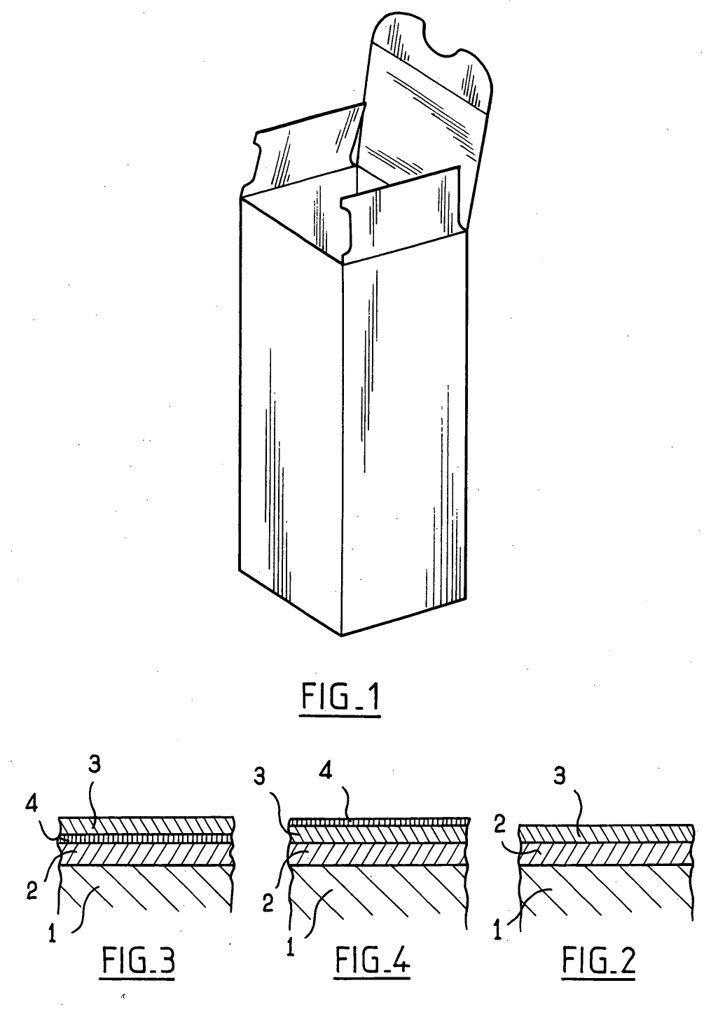

By way of example, such a box can present a generally rectangular shape, as shown in FIG. 1, having at least one fold-down flap at one end.

Naturally, the invention is not limited to a particular shape of packaging, and packaging having a wide variety of shapes can be made in accordance with the present invention, using a varnish-coated sheet of cardboard or the like, said packaging being designed to contain cigarettes or other objects, for example.

The packaging may comprise no more than the sheet of cardboard or the like, and the varnish coating the exposed outside surface of the packaging, so as to make it easier to recycle. In particular, the sheet of cardboard or the like need not include any laminated polymer film.

The sheet used can comprise a base 1 preferably of conifer fibers, therefore containing lignin, and, at least on the outside surface of the packaging, a surface coating 2 when the sheet is a sheet of coated cardboard. When the sheet includes cellulose fibers, said fibers may come from aspen trees, for example.

The surface coating 2 having a thickness that lies in the range 20 μm to 30 μm, for example, can improve the printability and the varnishing characteristics of the cardboard sheet and can improve the whiteness thereof.

By way of example, the coating layer 2 contains calcium carbonate and clay, in particular kaolin, in a weight ratio that is compatible with the manufacturing methods used, e.g. a weight ratio of 60/40.

The surface coating 2 need not have any protective compounds such as carbon black, or iron- or zinc-oxide, for providing protection against light.

The surface coating 2 can include at least one optical bleach at a concentration by weight lying in the range 0.05% to 0.5%, for example, or better in the range 0.1% to 0.3%.

In accordance with the invention, the cardboard sheet is coated on the outside surface of the packaging in a layer of varnish 3, said varnish containing at least one compound for protecting the sheet from the effects of light, in particular from yellowing as a result of visible and/or ultraviolet light, in particular at wavelengths lying in the range 290 nm to 460 nm.

The varnish 3, which may be colorless and need not substantially modify the color of the underlying sheet, contains at least a UV absorber compound and/or a free-radical absorber compound, for example.

The varnish 3 can be applied using various known techniques, e.g. heliography, flexography, silk-screen printing, or offset printing.

The thickness of the varnish deposited can depend on the deposition technique used, lying in the range approximately 2 μm for offset printing to approximately 20 μm for flexography. The thickness deposited preferably lies in the range 3 μm to 12 μm.

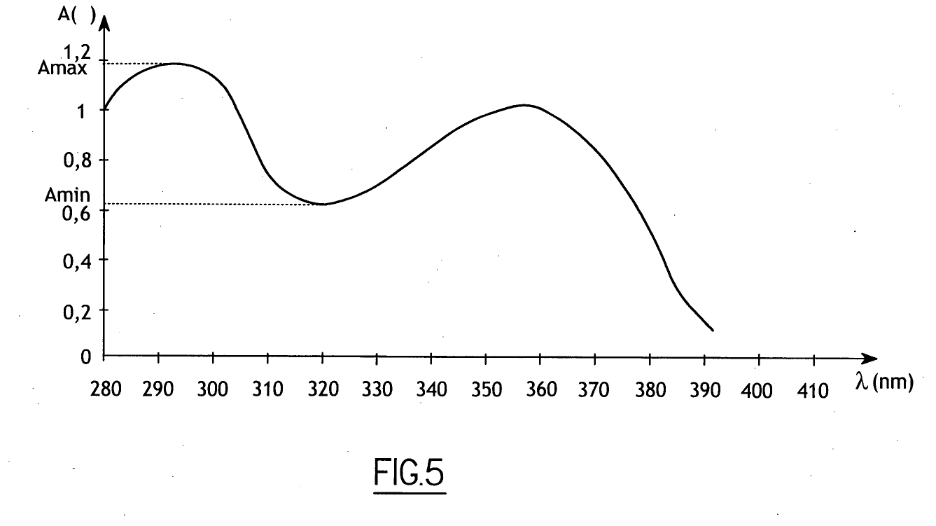

The varnish 3 is preferably applied after a pattern or design 4 has been printed on the sheet, as shown in FIG. 3, but in a variant, could be applied prior to applying the pattern 4, as shown in FIG. 4.

When the varnish 3 is applied after a pattern 4 has been printed on the sheet, the varnish 3 can usefully protect the inks of the pattern layer 4 from changing color.

The varnish 3 thus enables light-sensitive inks to be used such as fluorescents inks, for example, that are unstable or sensitive to the phenomenon of metamerism.

Numerous additives can be incorporated in the varnish 3 so as to obtain the desired protective function.

The concentration of the additive(s) can depend on their effectiveness, said effectiveness being proportional to their concentration and to the thickness of the layer of varnish in compliance with the BEER LAMBERT law. By way of example, the layer of varnish 3 can absorb a large fraction of light at wavelengths lying in the range 290 nm to 460 nm so as to increase the length of time that the packaging can be exposed to light before it reaches the same level of deterioration as packaging that does not have varnish, by at least 50%, for example, and better by 100%.

In the varnish 3, the concentration of additive(s) can typically lie in the range 0.5% to 10% by weight, and better in the range 1% to 6%, e.g. in the range 3% to 6%.

Suitable additives can, in particular, include those marketed by GREAT LAKES and CIBA-GEIGY, and can, in particular, include derivatives of the benzotriazole family.

Such derivatives can be heterocyclic compounds of the cyclo-benzene type, in which a carbon atom has been replaced.

By way of an example of a UV absorber compound, the following formula can be cited:

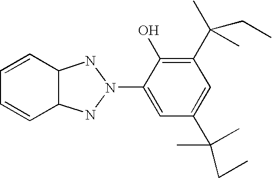

By way of an example of a free-radical absorber, the following formula can be cited:

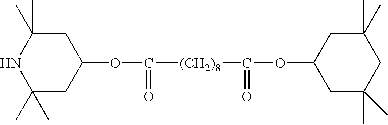

The free-radical absorber(s) used can be sterically-hindered amines (SHA), or else HALS.

The free-radical absorber(s) can stabilize the varnish and prevent the varnish itself from yellowing.

The type of varnish used can depend on the printing and drying methods used.

Long-oil offset-printing varnishes which yellow naturally by oxidization are preferably avoided.

A water-based varnish of the acrylic type can be used with a UV absorber and/or a free-radical absorber added thereto, e.g. with the two compounds whose formulae are given above added thereto.

A varnish that is cross-linkable under the action of ultraviolet radiation can also be used, but preferably avoiding the incorporation of sterically-hindered amines therein, since they would be destroyed in part by the varnish cross-linking.

When a varnish that is cross-linkable under the action of ultraviolet radiation is used, the varnish includes at least two UV absorbers, for example, each at a concentration that is less than 3% by weight, for example, and better not greater than 2%, and having absorption spectra that are selected so as to form between them a range of wavelengths in which the additives absorb less and enable a UV source to cause the varnish to cross-link.

By way of example, one of the additives is at a concentration of 2% and the other is at a concentration of 1%, so as to have a total concentration that is not greater than 3%.

By way of example, FIG. 5 shows the absorption spectrum of a varnish (for a path of 1 cm after dilution in the toluene at 20 mg/l) including two additives having absorption spectra that present respective peaks 10 and 11 forming between them a trough having an absorption low 12 that is, for example, centered on an emission wavelength of the source used to cross-link the varnish, e.g. 320 nm.

By way of example, the UV absorbers are:
a derivative of aromatic triazine such as that marketed by CIBA under the name TINUVIN 400, and having the following general formula: 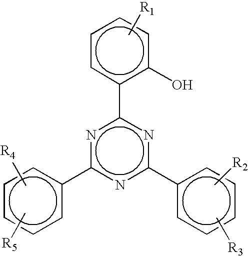
and a derivative of benzophenine such as that marketed by CIBA under the reference CGL 477, for example, and having the following general formula:

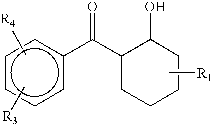

By way of example, the absorption low observed in the bottom 12 of the trough is at least 30% below the maximum absorption Aₘₐₓ observed for one of the peaks 10 and 11.

The varnish can include a violet dye so as to increase the whiteness of the sheet, the dye being at a concentration that is not greater than 1%, for example.

In order to demonstrate the protective effect against yellowing imparted by a varnish 3 of the invention, a test can be performed consisting in depositing a predefined quantity, e.g. 6 g/m², of wet water-based varnish on a cardboard sheet having a total thickness of 350 μm, then in exposing the sheet coated in this way to a mercury-vapor lamp for a predefined period of time. The concentration of additives in the varnish can reach 5% by weight, for example. An “Anilox” cylinder having a volume of at least 13 cubic centimeters (Cm³) can be used to apply the varnish.

Yellowing is measured on the blue wool scale, which corresponds to a blue scale of increasing light-fastness, standardized from 1 to 8.

Without varnish, measured yellowing can reach value 3 on the wool scale, for example. With varnish, measured yellowing can reach a value that is not less than 4, thereby demonstrating the higher resistance to yellowing of the cardboard sheet coated in varnish. The passage from value 3 to 4 corresponds to doubling of the duration of light stability.

When the varnish is a varnish that is UV cross-linkable, a diminution in yellowing can be observed over the period of time associated with subsequent cross-linking of the varnish over time, if the exposure to the artificial source for causing polymerization was not sufficient to polymerize the varnish fully.

Naturally, the invention is not limited to the embodiments described above, and it is possible, in particular, to use additives other than those mentioned above.

It is also possible to use cardboard sheets having surface coatings of some other composition, or indeed cardboard sheets without surface coatings.

Throughout the description, including in the claims, the term “comprising a” should be understood as being synonymous with “comprising at least one” unless specified to the contrary.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. Packaging comprising a cardboard sheet coated on an outside thereof in a varnish containing at least one additive for reducing deterioration of the packaging under an effect of light.

2. Packaging according to claim 1, wherein the cardboard sheet includes conifer fibers.

3. Packaging according to claim 2, wherein the cardboard sheet includes more than about 70% by weight of conifer fibers.

4. Packaging according to claim 2, wherein the cardboard sheet includes more than about 80% by weight of conifer fibers.

5. Packaging according to claim 1, wherein the additive absorbs a large fraction of light radiation at wavelengths lying in the range from about 290 nm to about 460 nm.

6. Packaging according to claim 1, wherein the cardboard sheet includes a surface coating.

7. Packaging according to claim 6, wherein the surface coating is white.

8. Packaging according to claim 6, wherein the surface coating contains at least one optical bleach.

9. Packaging according to claim 8, wherein the optical bleach in the surface coating is at a concentration by weight lying in a range from about 0.05% to about 0.5%.

10. Packaging according to claim 9, wherein the optical bleach is at a concentration lying in a range from about 0.1% to about 0.3%.

11. Packaging according to claim 6, wherein the surface coating has thickness lying in a range from about 20 μm to about 30 μm.

12. Packaging according to claim 6, wherein the surface coating contains calcium carbonate.

13. Packaging according to claim 6, wherein the surface coating contains clay.

14. Packaging according to claim 13, wherein the surface coating contains kaolin.

15. Packaging according to claim 13, wherein the surface coating contains calcium carbonate and clay substantially in a 60/40 ratio by weight.

16. Packaging according to claim 6, wherein the surface coating contains starch.

17. Packaging according to claim 1, wherein the cardboard sheet weighs not less than about 100 g/m2.

18. Packaging according to claim 1, wherein the cardboard sheet weighs not less than about 190 g/m2.

19. Packaging according to claim 1, wherein the cardboard sheet weighs not less than about 200 g/m2.

20. Packaging according to claim 1, wherein a thickness of the varnish lies in a range from about 2 μm to about 20 μm.

21. Packaging according to claim 20, wherein the thickness of the varnish lies in a range from about 3 μm to about 12 μm.

22. Packaging according to claim 1, wherein, in the varnish, the additive is at a concentration by weight lying in a range from about 0.5% to about 10%.

23. Packaging according to claim 22, wherein, in the varnish, the additive is at a concentration by weight lying in a range from about 3% to about 6%.

24. Packaging according to claim 1, wherein the additive comprises a UV absorber compound.

25. Packaging according to claim 24, wherein the additive is comprises a UV absorber having a formula:

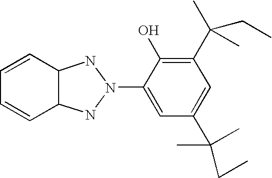

26. Packaging according to claim 1, wherein the additive comprises a free-radical absorber compound.

27. Packaging according to claim 26, wherein the additive comprises at least one of a sterically-hindered amine and a hindered amine light stabilizer.

28. Packaging according to claim 26, wherein the additive comprises a free-radical absorber compound having a formula:

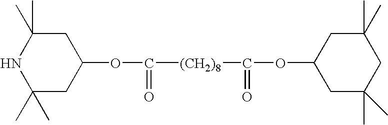

29. Packaging according to claim 1, wherein the varnish comprises a varnish that is cross-linkable under an action of UV radiation.

30. Packaging according to claim 29, wherein the varnish includes at least two ultraviolet absorbers having absorption spectra that are selected so as to form a range of wavelengths in which absorption is lower.

31. Packaging according to claim 1, wherein the varnish includes a violet dye.

32. Packaging according to claim 30, wherein a trough formed between absorption peaks of the at least two ultraviolet absorbers is substantially centered in a range from about 310 nm to about 330 nm.

33. Packaging according to claim 1, wherein the varnish is based on an aqueous solvent.

34. Packaging according to claim 33, wherein the varnish comprises an acrylic varnish.

35. Packaging according to claim 1, wherein the cardboard sheet is of the SBS type.

36. Packaging according to claim 1, wherein, before drying, the cardboard sheet is coated in approximately 3 g/m2 to 10 g/m2 of varnish.

37. Packaging according to claim 36, wherein the cardboard sheet is coated in approximately 6 g/m2 of varnish.

38. Packaging according to claim 1, wherein the varnish covers printing on the cardboard sheet.

39. Packaging according to claim 1, including printing on the varnish.

40. Packaging according to claim 1, wherein the cardboard sheet includes a base layer including cellulose fibers.

41. Packaging according to claim 40, wherein the cardboard sheet includes a base layer including fibers from aspen wood.

42. Packaging according to claim 1, wherein the cardboard sheet includes lignin.

43. Packaging according to claim 1, wherein a weight of the cardboard sheet is not greater than about 320 g/m2.

44. A method of manufacturing packaging comprising a cardboard sheet, in which method a varnish is applied to the sheet, said varnish containing at least one additive for reducing deterioration of the sheet under an effect of light.

45. A method according to claim 44, wherein the additive comprises at least one of a UV absorber compound and a free-radical absorber.

46. A method according to claim 44, wherein the varnish is applied by at least one of offset printing, heliography, flexography, and silk-screen printing.

47. A method according to claim 44, wherein the sheet is printed prior to the varnish being applied.

48. A method according to claim 44, wherein the sheet is printed after the varnish has been applied.

49. A method according to claim 44, wherein the varnish is cross-linkable under action of ultraviolet radiation, and includes at least two ultraviolet absorbers selected to have absorption spectra that are sufficiently far apart to form between them a range of wavelengths in which absorption is lower, and wherein a source emitting in the range of wavelengths is used to cause the varnish to cross-link.

50. A method according to claim 49, wherein absorption peaks of the two absorbers are more than about 40 nm apart, and form between them a trough in which an absorption low is at least about 30% below a maximum absorption defined by at least one of the peaks.

51. A cardboard sheet serving to make packaging as defined in claim 1.
